(19) United States
(12) Patent Application Publication
(10) Pub. No.: US 2003/0145835 A1
(43) Pub. Date: Aug. 7, 2003

(54) Drive shaft seal for gasoline direct injection pump

(75) Inventor: Ilija Djordjevic, East Granby, CT (US)

Correspondence Address: ALIX YALE & RISTAS LLP, 750 MAIN STREET, SUITE 1400, HARTFORD, CT, 06103, US

(73) Assignee: Stanadyne Corporation

(21) Appl. No.: 10/071,946

(22) Filed: Feb. 5, 2002

(51) Int. Cl. F02M 37/04; F16J 15/32

(52) U.S. Cl. 123/495; 277/353

(57) ABSTRACT

A drive shaft seal for a gasoline direct injection pump is configured as a solid but flexible barrier separating combustion fluid from lubrication fluid in the pump. Each drive shaft seal is generally disc shaped, defining a central shaft opening surrounded by a flexible corrugated portion that is in turn surrounded by a generally planar outer flange. The outer flange of each shaft seal is retained between pump housing sections and sealed by stationary o-rings. An axially projecting lip retained and sealed between a bushing and a shoe race defines the shaft opening. The bushing, shoe race and associated pump components move reciprocally in response to rotation of a shaft mounted eccentric. The corrugated flexible portion of each drive shaft seal flexes to accommodate relative movement between the inner lip and outer flange. No part of the drive shaft seal is in contact with the rotating shaft.

### BACKGROUND OF THE INVENTION

1. Field of the Invention

The present invention relates to pumps and, more particularly, to a seal for maintaining separation of lubricating oil and fuel in a high pressure supply pump for a gasoline direct injection system.

2. Description of the Related Art

Pumps capable of generating relatively high pressure (such as 120 bar and higher) required for supplying a common rail used in gasoline direct injection (GDI) systems are well known in the art. One such pump is described in U.S. patent application Ser. No. 09/342,566, filed Jun. 29, 1999 and entitled “Supply Pump for Gasoline Common Rail” which is assigned to the Assignee of the present invention, and the entire contents of which is hereby incorporated by reference. This supply pump includes a rotating drive shaft supported by bearings that are lubricated by a lubrication fluid (oil) as is typical in the art. Oil lubricated drive shaft bearings are typically required due to the poor lubricating properties of gasoline. In this pump configuration, energy transfer from the drive shaft to the pumping plungers, e.g., high speed sliding motion between the drive shaft eccentric and the shoes associated with each pumping plunger driven end, takes place in a bath of gasoline. The gasoline in the low pressure area (sump) of the pump may be pre-pressurized to 4 or 5 bar by a separate feed pump, e.g., remotely located in a fuel tank. Seals, such as lip seals, which extend radially about the rotating shaft are employed to prevent escape and/or mixing of either fluid.

A problem can occur with the typical prior art lip seals in that because of the differences in pressure between the lubricating oil pressure and fuel pressure within the pump, the lip seals may be canted one way or the other into contact with the rotating shaft, resulting in premature seal wear. It should be understood that lip and other sliding contact seals are by definition wear items whose seal degrades over time. Additionally, typical elastomeric seal materials become rigid and inflexible in extreme cold conditions, causing the seal to remain deformed as a result of idle periods at cold temperatures. All of these conditions produce gaps through which the pressure differential between the oil and the fuel promotes passage either of oil into the fuel or fuel into the oil, resulting in undesirable mixing of these fluids. In one direction, mixing of the fuel into the oil may result in a reduction in lubricity of the oil. It will be appreciated that reduced lubricity of the oil can, for example, result in premature wear of the engine. Also, potential hazardous waste problems concerning disposal of the oil/fuel mixture can arise. In the opposite direction, the mixing of the oil with the fuel may result in a reduction in engine performance by causing premature ignition (knock) and an undesirable increase in engine emissions.

Any seal consisting of stationary and rotating components, such as the stationary lip seals and rotating shaft described above, will be inherently very sensitive to contamination during assembly as well as to deterioration by wear or contamination during extended operation. Both scenarios can lead to leakage, with serious adverse consequences to the engine and/or the passengers. In addition, the most sophisticated and durable mechanical seals tend to be very expensive, cumbersome and generate large amounts of friction-related heat.

There is a need in the art for a more reliable drive shaft seal that overcomes the above-described deficiencies.

### SUMMARY OF THE INVENTION

An object of the present invention is to provide a new and improved drive shaft seal for use in conjunction with high pressure gasoline supply pumps that substantially eliminates mixing of lubricating oil with fuel.

Another object of the present invention is to provide a new and improved drive shaft seal for a high pressure gasoline supply pump that permits construction of the pump with a reduced number of simplified components.

A further object of the present invention is to provide a new and improved drive shaft seal for a high pressure gasoline supply pump that substantially eliminates seal-related heat generation.

A yet further object of the present invention is to provide a new and improved drive shaft seal for a high pressure gasoline supply pump that minimizes high speed sliding contact between components bathed in gasoline.

These and other objects of the invention are achieved in a preferred embodiment of the drive shaft seal comprising a flexible barrier for separation of the fuel from lubricated portions of the pump. One embodiment of the drive shaft seal is generally disk-shaped, defining a central shaft opening surrounded by a flexible corrugated portion which is in turn surrounded by a flat outer flange. The planar outer flange of each shaft seal is sandwiched between pump housing segments and sealed by stationary o-rings. A radially inner, axially projecting cylindrical section defines the shaft opening. The cylindrical section is sandwiched and sealed between a radially inward bushing and a radially outer shoe race and sealed by stationary o-rings disposed in grooves defined by the bushing and shoe race respectively. The drive shaft, or cantilever end of an engine shaft, passes through the bushing and never actually contacts the drive shaft seal. The sliding interface between the rotating shaft and bushing may be executed as a dry lubricated bushing, may be lubricated by engine oil and/or equipped with a needle bearing or the like.

In a supply pump having its own shaft, the front and rear housing segments support the shaft on lubricated roller and/or needle bearings. Clamping and mounting screws align and tightly clamp the pump housing sections together with the flat, radially outer flanges of the drive shaft seals retained between them.

In a supply pump driven by a cantilevered extension of an engine shaft, the pump itself will have no bearings because the engine shaft is supported by bearings internal to the engine. The pump will utilize a shortened housing and require only one drive shaft seal (to keep fuel from leaking into the bearing supporting the engine shaft). Mounting hardware for the pump will clamp the radially outer flange of the drive shaft seal between the pump housing and the engine or adapter plate. An eccentric on the end of the engine shaft will rotate within a bushing as described above.

The pump shaft will have at least one portion defining an external profile that is eccentric with respect to the axis of shaft rotation. In the inventive pump, the external profile of the eccentric is engaged in sliding contact with the interior surface of the bushing. The bushing is preferably stationary with respect to the radially inner cylindrical section of each diaphragm and the shoe race that supports the radially inner end of the pump plungers. Thus, the sealing diaphragms are not subject to the wear that is typical of a lip seal because all sliding contact takes place between the external surface of the eccentric and the bushing.

The flexible portion of each sealing diaphragm has a folded or corrugated configuration. This corrugated configuration permits the radially inner cylindrical lip to move relative to the radially outer flange in response to reciprocal forces generated by the eccentric. The seal materials and corrugated configuration ideally combine to withstand many millions of reciprocal pump cycles while maintaining a continuous barrier between combustion and lubrication fluids in the pump. The corrugations may be in the form of concentric axial folds or alternatively, may be radial folds. The radial folds of seal material will together provide the seal with an axial component, or cup-like configuration from the radially outer flange to the inner shaft opening.

### BRIEF DESCRIPTION OF THE DRAWINGS

FIG. 1 is a sectional view through a supply pump for a gasoline direct injection system including a pair of drive shaft seals in accordance with the present invention;

FIG. 2 is an overhead perspective view of one drive shaft seal as shown in FIG. 1;

FIG. 3 is an overhead perspective view of an alternative embodiment of a drive shaft seal in accordance with the present invention;

FIG. 4 is a sectional view through an alternative supply pump for a gasoline direct injection system incorporating a single drive shaft seal as illustrated in FIG. 2;

FIG. 5 is a sectional view through the supply pump of FIG. 4 incorporating the alternative drive shaft seal illustrated in FIG. 3;

FIG. 6 is a sectional view through an alternative supply pump for a gasoline direct injection system incorporating an alternative embodiment of a drive shaft seal in accordance with the present invention; and

FIG. 7 is a sectional view through the supply pump of FIG. 6 incorporating a further alternative embodiment of a drive shaft seal in accordance with the present invention.

### DETAILED DESCRIPTION OF THE PREFERRED EMBODIMENTS

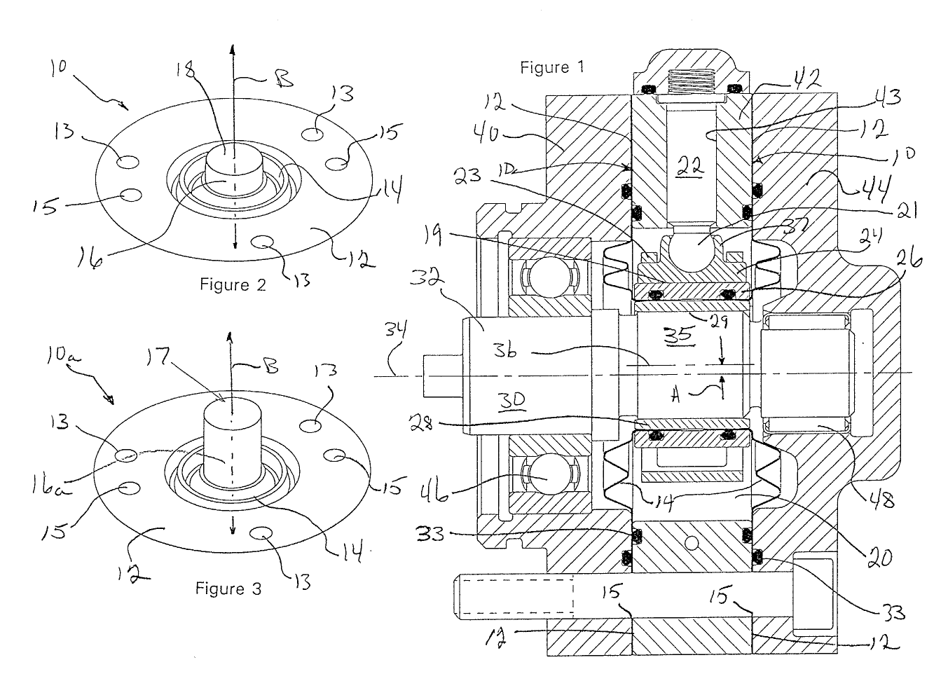

With reference to the drawings, wherein like numerals represent like parts throughout the several Figures, one preferred embodiment of a drive shaft seal in accordance with the present invention is generally designated by the numeral 10. FIG. 1 is a sectional view through a supply pump appropriate for use in conjunction with a gasoline direct injection (GDI) system. The illustrated pump is constructed from three primary sections. An adapter plate 40 is configured to mate with a complementary opening on an internal combustion engine (not illustrated). The adapter plate 40 includes a first bearing 46 to support one end of the pump drive shaft 32. The engine end of the pump drive shaft 32 includes a tang drive which mates with complementary parts of an engine driven shaft (not illustrated) to impart rotational energy to the pump drive shaft 32. The middle section 42 of the pump contains integral plunger bores 43 and preferably also ducts for transmitting low pressure fuel to the pump plunger bores 43 and providing a passage for high pressure fuel away from the pump plungers 22. A pump cover 44 encloses the outer end of the pump and includes a second bearing 48 for supporting the outer end of the pump drive shaft 32. FIGS. 2 and 3 show that the outer flange of each seal defines five through holes 13, 15 to permit passage of fasteners. Two assembly fasteners (not illustrated) pass through the pump cover, outer seal holes 15, pump middle section 42 and inner seal holes 15 to threadably engage the adapter plate to align the pump sections and clamp the pump into an assembled unit. After testing and calibration, the pump is then installed to the engine by three mounting fasteners that pass through all three pump sections and flange through holes 13 to threadably engage the engine block.

The pump drive shaft 32 has a primary axis of rotation 34 defined by bearings 46 and 48. As is typical in a radial piston pump, the pump drive shaft includes an eccentric portion 35 having an axis of rotation 36 offset by a distance A from the shaft axis 34. Rotation of the shaft 32 produces an oscillatory movement of the eccentric 35 relative to the pump housing sections 40, 42, 44. In the illustrated embodiment, the oscillatory movement of the eccentric 35 is transmitted to the pump plungers 22 through a bushing 28, a shoe race 26 surrounding the bushing and plunger shoe 24. The inward end, or head 21 of the pump plunger 22 is pivotally retained to the shoe 24 in a socket 37. It should be noted that, although one plunger 22 is illustrated in FIGS. 1, 4 and 5, the illustrated radial GDI pumps will typically incorporate a plurality of plungers 22 and associated shoes 24 with a preferred number being three. Retention means such as the energizing rings 23 urge the shoes 24 against the exterior of the shoe race 26. Together the bushing 28, shoe race 26, shoes 24 and energizing rings 23 follow the movement of the eccentric 35 to produce reciprocal actuation of the plungers 22 in their bores 43.

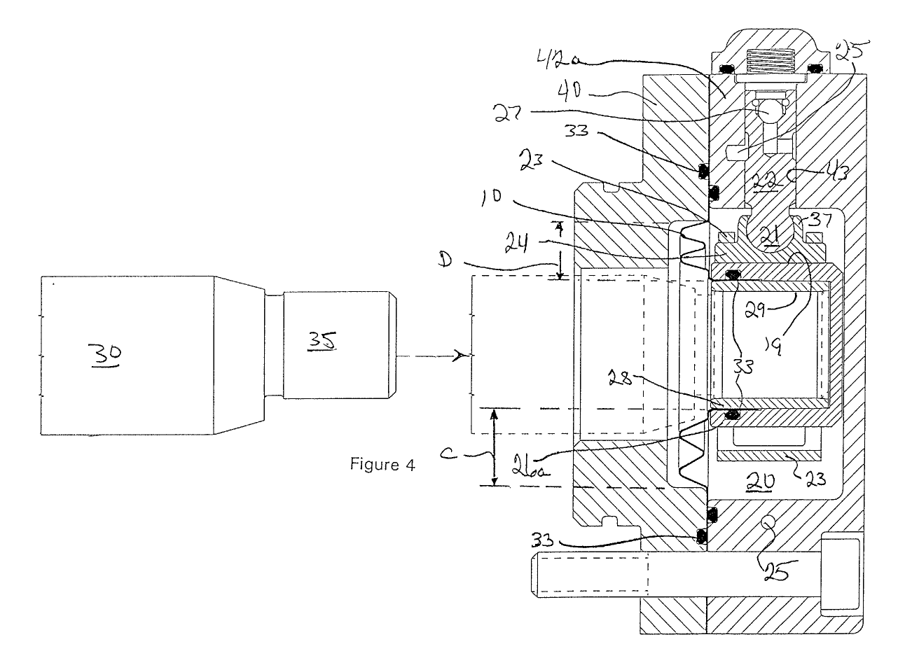

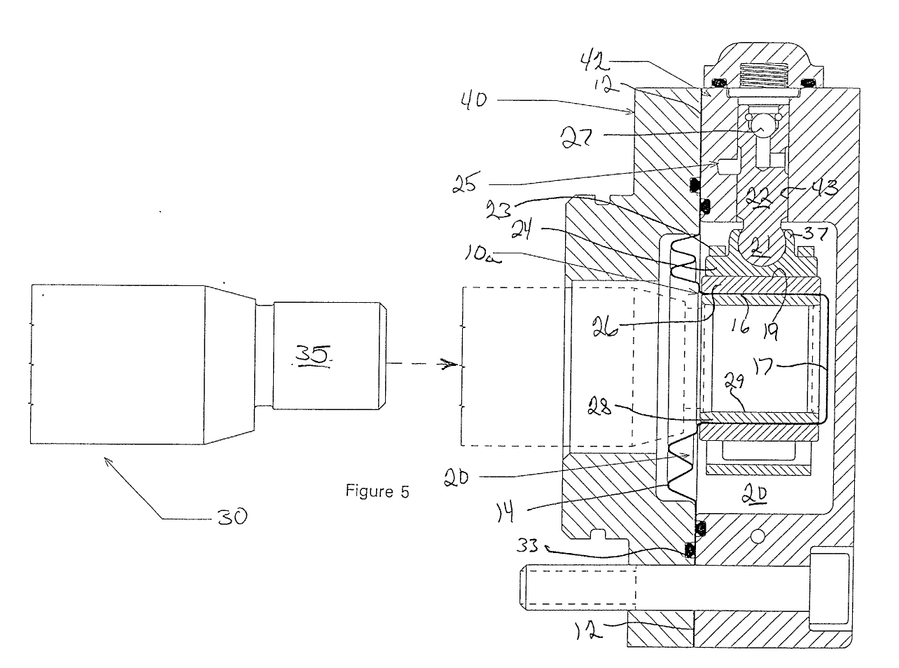

It will be appreciated by those of skill in the art that two dissimilar fluids are present within the GDI pump. The combustion fluid, in this case gasoline, fills a sump 20 that surrounds the radially inward end, or head 21 of the pumping plungers 22 to be drawn into pumping chambers defined at the radially outward end of each plunger and pressurized by radially outward movement of the plungers 22 induced by the eccentric 35. The fuel may be drawn into the pumping chambers from the sump 20 through openings and passages in the pumping plungers 22 as described in U.S. patent application Ser. No. 09/342,566, incorporated by reference above. Alternatively, low pressure feed passages 25 may supply fuel to the middle section of the plunger bore 43 as illustrated in FIGS. 4 and 5. In either configuration, it will be understood that fuel, e.g., gasoline surrounds the head 21 of each plunger 22 and fills the sump 20.

Lubrication fluid preferably surrounds the drive shaft bearings 46 and 48. Bearings 46 and 48 may be permanently lubricated by grease or may be provided with a stream of lubrication fluid from the engine lube oil supply. In either case, the presence of gasoline in that area of the pump containing lubrication fluid will dissolve the lubrication fluid resulting in loss of lubrication, overheating and possible catastrophic failure of the pump.

One critical aspect of the GDI pump addressed by the present invention is realization of a reliable drive shaft seal which will separate the combustion fluid (gasoline) from lubrication fluids (oil, grease) necessarily present in the pump. As previously discussed, the typical prior art GDI pump includes seals consisting of radially projecting lips of elastomeric material arranged to abut the rotating exterior surface of the drive shaft. These so-called lip seals are subject to failure during all stages of assembly and operation of the GDI pump, resulting in unacceptable mixing of combustion and lubrication fluids. The present invention replaces these lip seals with a continuous barrier between the fluids having no contact with the rotating shaft 32. In a first embodiment shown in FIG. 1, two drive shaft seals 10 arranged to define a sump chamber 20 surrounding the radially inward ends of the pump plungers 22.

As best seen in FIG. 2, each drive shaft seal 10 comprises a radially outward flange 12 configured for retention between pump housing components such as the adapter plate 40, middle section 42 and cover 44. Each drive shaft seal 10 of this first illustrated embodiment defines an axial opening 18 surrounded by an axially projecting lip 16. Between the lip 16 and the flange 12 are a series of concentric bellows-type folds in the seal material. Seal material is accumulated in axial folds radially progressing away from the axial opening in concentric rings. These bellows folds permit movement of the lip 16 relative to the flange 12. With reference to FIG. 1, the flanges 12 of the two drive shaft seals 10 are retained between the adapter plate 40 and middle section 42 and cover 44, respectively. The lips 16 are arranged to project axially toward each other and be retained between the bushing 28 and the shoe race 26. Sealing grommets or o-rings 33 are arranged in grooves defined by the pump sections and shoe race 26 to enhance sealing engagement of the drive shaft seals 10 with these pump components.

It will be apparent that no sliding contact occurs between the rotating drive shaft 32 and the drive shaft seals 10. The bushing 28 provides a sliding interface 29 with the eccentric 35 of the drive shaft 32. As the pump drive shaft 32 rotates, the eccentric 35 imparts a reciprocal motion to each pumping plunger 22 as previously described. The flexible portion 14 of each drive shaft seal 10 flexes to permit movement of the lip 16 relative to the flange 12 during each pumping cycle.

It will be noted that the sliding interface 29 eliminates a sliding interface between the plunger shoe 24 and the eccentric 35 found in previous pumps (see U.S. application Ser. No. 09/342,566, incorporated by reference above). The interface 19 between the shoe race 26 and shoes 24 in the illustrated pump embodiments serves only to transmit reciprocal energy to the pumping plunger 22 and is not a high speed sliding interface. This simplified force-distribution relationship between the shoe race 26 and the shoe 24 may support increased loads on the plunger head 21 and shoe 24 in the form of higher pump output pressure or increased pump output volume.

FIG. 1 illustrates the eccentric 35 having just completed the upward reciprocal movement of pumping plunger 22. The flexible portion 14 of each drive shaft seal 10 is shown to be compressed adjacent the pumping plunger 22, e.g., above the drive shaft 32. The flexible portion 14 is expanded at the opposite side of the pump, e.g., below the drive shaft 32. Appropriate selection of drive shaft seal materials and the configuration of the bellows folds comprising the flexible portion 14 permit construction of a drive shaft seal that can easily withstand millions of such compression/expansion cycles. A metallic barrier such as that described herein also has the advantage of being able to withstand minor pressure differentials that may occur between the combustion fluid in the sump chamber 20 and lubrication fluid outside the sump. The drive shaft seals may be displaced slightly inwardly or outwardly by such pressure differentials without adversely affecting their function or increasing wear. Combustion fluid cannot pass through the impervious barrier presented by drive shaft seals 10. Meanwhile, lubricating oil is free to move through the bearings 46 and 48 as well as the interface 29 between the bushing 28 and the eccentric 35, without mixing with the combustion fluid in the sump chamber 20.

An alternative embodiment of a GDI pump is illustrated in FIGS. 4 and 5. The alternative embodiment is a GDI pump driven by a cantilevered extension of an engine driven shaft, such as a camshaft 30. Using a cantilevered extension of an engine shaft simplifies pump design by eliminating the need for an internal pump shaft and its associated bearings. The simplified pump includes an adapter plate 40 and a combined middle section/cover 42a. An eccentric 35 is preferably an integral part extending from one end of the engine shaft 30. When the pump is mounted to an engine (not illustrated), the eccentric 35 penetrates through the adapter plate 40 to engage the pump bushing 28. Rotation of the engine shaft 30 imparts reciprocal movement to the pump plunger 22 in a manner identical to that described above with reference to the pump illustrated in FIG. 1.

Elimination of the pump shaft and associated bearings simplifies the pump design and permits a single drive shaft seal 10 to separate the combustion fluid in the sump chamber 20 from lubrication fluid in the engine. The radially projecting flange 12 of the drive shaft seal 10 is compressively engaged between the adapter plate 40 and the middle section/cover 42a. The axially projecting lip 16 is retained between the bushing 28 and an alternative shoe race 26a. The shoe race 26a illustrated in FIG. 4 is configured as a cap which extends over the end of the bushing 28 and eccentric 35 to complete the barrier between engine lubrication fluid and combustion fluid in the sump chamber 20. Sealing grommet 33 keeps combustion fluid from moving past the drive shaft seal 10 by migrating between the shoe race 26a and the bushing 28. The bushing 28 provides a sliding interface 29 with the eccentric 35.

The eccentric in FIG. 4 is illustrated at the completion of its upward movement. Thus, the flexible portion 14 of the drive shaft seal above the drive shaft is compressed to a radial dimension D. A diametrically opposed flexible portion is expanded to a radial dimension C to accommodate upward movement of the lip 16 relative to the flange 12. Continued rotation of the engine shaft 30 will produce a downward reciprocal movement on the pumping plunger 22 to draw combustion fluid through low pressure input passage 25 and check valve 27 into a pumping chamber (not shown) defined at the radially outward end of the plunger 22. The next upward movement of the eccentric 35 will close check valve 27 and expel the combustion fluid from the pumping chamber at an elevated pressure.

FIG. 5 illustrates the pump of FIG. 4 equipped with an alternative embodiment 10a of the drive shaft seal. This embodiment of the drive shaft seal forms a closed cap 17 over the end of the pump bushing 28 and eccentric 35. This eliminates the need for the special shoe race 26a illustrated in FIG. 4. In all other respects the pump and drive shaft seal 10a operate as previously described.

As best seen in FIGS. 2 and 3, each drive shaft seal 10, 10a defines a central axis B passing through the axially projecting lip 16, 16a. It will be understood that the lips 16, 16a project substantially perpendicularly to the radially projecting flange 22. The folded flexible portions 14 can be arranged and configured to comply with pump spatial and/or other design constraints. The illustrated drive shaft seals 10, 10a, are arranged so that the bellows-fold flexible portion 14 projects axially away from the lip 16, 16a. Other configurations are of course possible. The illustrated embodiments 10, 10a illustrate one and one-half bellows folds surrounding the axially projecting lips 16, 16a. The flexible portion 14 may include greater or fewer numbers of bellows folds having a greater or smaller axial dimension depending on the material used, spatial or other design constraints.

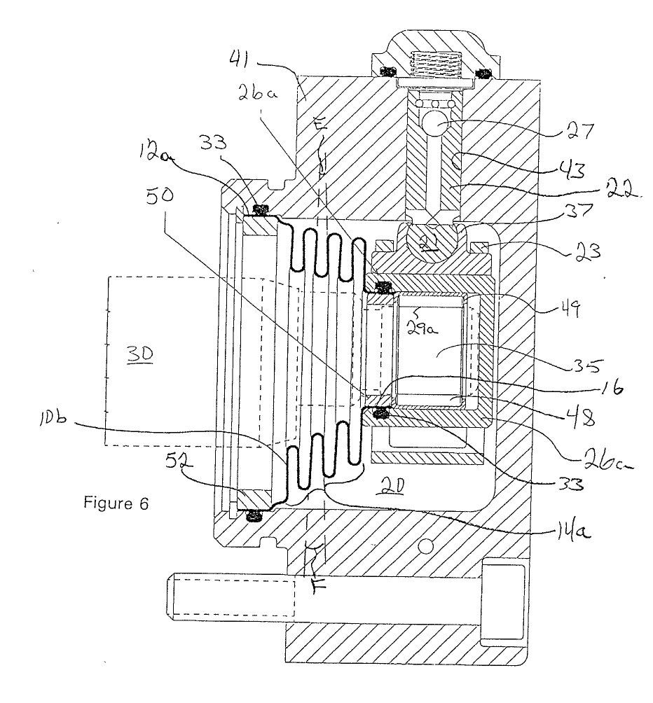

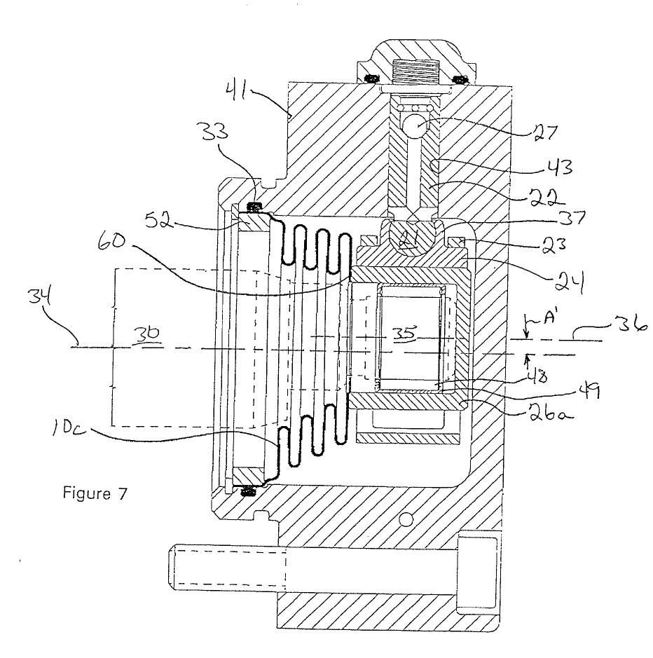

FIGS. 6 and 7 illustrate a further alternative embodiment of a GDI pump driven by a cantilevered extension of and engine shaft. This pump embodiment has a pump body 41 formed as a single unit. The pump illustrated in FIGS. 6 and 7 replaces the bushing 28 illustrated in FIGS. 1, 4 and 5 with a needle bearing 48. A needle bearing 48 changes the relationship between the eccentric 35 and the shoe race 26, 26a from a sliding interface 29 to a more efficient rolling interface 29a capable of sustaining much larger forces over greater periods of time. The needle bearing may be pre-lubricated or supplied with oil mist or flow as is known in the art.

An alternative shaft seal 10b incorporates a flexible portion 14a comprising a sequence of radial folds that progress in an axial direction. This embodiment of the shaft seal has a axial dimension extending from the outer flange 21a to the inner lip 16. The outer flange 12a projects in an axial direction and is trapped between the pump body 41 and a press fit retention ring 52. A sealing grommet 33 enhances the seal established between the outer flange 12a and the pump body 41. The inner lip 16 (FIG. 6) is similarly trapped between a retention ring 50 and the cap-shaped shoe race 26a.

With continuing reference to FIG. 6, the eccentric is illustrated as just having completed the upward pumping stroke of the plunger 22. Thus, that portion of the shaft seal 10b above the shaft 30 is compressed and the opposite portion is expanded. This is reflected in the angles between consecutive of the radial folds making up the flexible portion 14a. Above the shaft 30, the compressed radial folds form a narrow acute angle E. Below the shaft, the expanded radial folds form a larger acute angle F. Finite element analysis indicates that a plurality of radial folds as in embodiment 10b permit a greater eccentricity of the eccentric relative to the shaft axis 34 (see FIGS. 1 and 7). This, combined with an improved rolling interface 29a between the eccentric 35 and the shoe race 26a, permit an increased pumping volume and pressure output for the pump embodiment of FIGS. 6 and 7 as compared to the pump illustrated in FIGS. 4 and 5.

FIG. 7 illustrates a further alternative embodiment of the shaft seal 10c in which the inner lip is eliminated and replaced with a welded interface 60 between the final radial fold and the open end of the cup-shaped shoe race 26a. This welded interface 60 provides a permanent fluid-tight connection between the seal 10c and the shoe race 26a. FIG. 7 also illustrates the radial eccentricity A′ of the eccentric 35 relative to the shaft axis of rotation 35. It will be noted that shaft eccentricity A′ in FIG. 7 is greater than shaft eccentricity A in FIG. 1. Needle bearings 48 are provided with an outer race 49 that is closely received within the shoe race 26a. In the illustrated embodiments, eccentric 35 will be provided with a hardened surface to serve as the inner race for the needle bearings.

It should be noted that all the illustrated pump embodiments eliminate high speed sliding motion between the shoe 24 and an actuating surface, e.g., the eccentric. Absence of sliding motion reduces loading on the shoe 24 and allows for an increase in pressure produced by the pump and/or an increase in the volume of fuel delivered by the pump.

Each drive shaft seal is preferably formed from thin and flexible stainless steel, although other materials are of course possible. A preferred embodiment of the drive shaft seal comprises a sheet of 300 or 400 series stainless steel having a thickness of between 0.08 and 0.12 millimeters. The thickness of the seal material will depend in part upon the pressure inside the sump. Thicker material may be necessary to withstand higher sump pressures. It will be understood that the material will be the thinnest appropriate for the given sump pressure because thinner materials will have reduced internal stress, as is known in the art. Alternatively, the seal may be made from Beryllium Copper alloy or, in low sump pressure applications, glass or carbon fiber reinforced plastic or elastomeric materials.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed is:

1. A pump comprising:
a pump body comprising pumping means for pumping a combustion fluid;
a shaft rotatable relative to said pump body and including a drive portion for driving said pumping means, said shaft supported on bearings lubricated by a lubrication fluid;
bushing means in contact with said drive portion for providing a sliding interface with said drive portion; and
a shaft seal for preventing mixture of said combustion fluid and said lubrication fluid, said shaft seal comprising:
a fluid impervious diaphragm surrounding a central axis perpendicular to said diaphragm, said diaphragm comprising an outer flange radially spaced from said central axis, an inner lip defining an opening for receiving said shaft and a flexible portion intermediate said flange and said lip,
wherein said flange is fixed and sealed to said pump housing and said lip is fixed and sealed to said bushing means, said flexible portion permitting oscillatory movement of said bushing means relative to said pump housing while maintaining a fluid impervious barrier between said combustion fluid and said lubrication fluid.

2. The pump of claim 1, wherein said drive portion comprises a cylindrical section having an axis of rotation offset from an axis of rotation of said drive shaft.

3. The pump of claim 1, wherein said flexible portion comprises a series of concentric folds.

4. The pump of claim 1, wherein said inner lip projects generally perpendicularly from said diaphragm and generally parallel to said drive portion.

5. The pump of claim 1, wherein said pump housing comprises a plurality of housing sections and said outer flange is compressively engaged between two of said housing sections.

6. The pump of claim 5, wherein said housing sections comprise channels adjacent said outer flange for retaining resilient sealing means for sealing said outer flange to said housing.

7. The pump of claim 4, wherein said bushing means comprises an inner bushing for sliding engagement with said drive portion and an outer race surrounding said inner bushing and said inner lip is compressively engaged between said inner bushing and said outer race.

8. The pump of claim 7, wherein said inner bushing and said outer race comprise channels adjacent said inner lip for retaining resilient sealing means for sealing said inner lip to said bushing means.

9. The pump of claim 1, wherein said housing comprises an adapter plate and a pump section, said outer flange being compressively engaged between said adapter plate and said pump section such that said pump section and shaft seal define a sump chamber for said combustion fluid.

10. A shaft seal for an injection supply pump comprising a housing defining a sump, a plurality of radial plungers reciprocated by an eccentric fixed to a rotating shaft, wherein radial force is delivered from said eccentric to a radially inward head of said plungers by a shoe race surrounding said eccentric, said shaft seal comprising:
a diaphragm surrounding a central axis, said diaphragm comprising:
an outer flange radially spaced from said central axis and sealingly fixed to said pump housing;
inner sealing means for sealingly fixing said seal to said shoe race; and
a flexible portion intermediate said bushing receptacle and said outer flange and generally parallel to said outer flange,
wherein said outer flange and flexible portion are formed from a homogeneous continuous sheet and said sheet provides a fluid impervious barrier containing a combustion fluid in said sump and no part of said shaft seal is in sliding contact with said shaft.

11. The shaft seal of claim 10, wherein said homogeneous continuous sheet comprises a material selected from the group of materials consisting of stainless steel, Beryllium Copper alloy, fiber reinforced plastic or fiber reinforced elastomeric material.

12. The shaft seal of claim 10, wherein said homogeneous continuous sheet is 300 or 400 series stainless steel having a thickness of between 0.08 and 0.12 mm.

13. The shaft seal of claim 10, wherein said shaft seal has a generally circular configuration and said flexible portion comprises at least one circular bellows folds in said continuous sheet.

14. The shaft seal of claim 10, wherein said flexible portion comprises a plurality of parallel circular bellows folds in that portion of said continuous sheet connecting said outer flange to said inner sealing means.

15. The shaft seal of claim 10, wherein said inner sealing means comprises a welded joint between said seal and said shoe race.

16. The shaft seal of claim 10, wherein said inner sealing means comprises an axially projecting lip compressed between said shoe race and a bushing, said bushing being in sliding contact with said eccentric.

17. The shaft seal of claim 10, wherein said inner sealing means comprises an axially projecting lip compressed between said shoe race and a retention ring.

18. A drive shaft seal comprising:
means for providing a sliding interface with a rotating drive shaft; and
a generally circular sheet of fluid impervious material comprising:
an outer flange; and
a corrugated portion between said outer flange and an axial shaft opening, said corrugated portion comprising a plurality of concentric repeating bends in said sheet,
wherein said bushing lip is fixed and sealed to said means for providing a sliding interface to provide a fluid impervious barrier extending radially from said means for providing a sliding interface and said flexible portion permits relative movement between said means for providing a sliding interface and said outer flange.

19. The drive shaft seal of claim 15, wherein said sheet of fluid impervious material is a metal selected from the group consisting of stainless steel, beryllium copper alloy, fiber reinforced plastic and fiber reinforced elastomeric material.

20. The drive shaft seal of claim 15, wherein said sheet of fluid impervious material has a thickness between 0.08 and 0.12 mm.
